(19) United States
(12) Patent Application Publication
(10) Pub. No.: US 2007/0284158 A1
(43) Pub. Date: Dec. 13, 2007

(54) Method and system for controlling charge and discharge amounts of a main battery for a hybrid car

(76) Inventor: Yong Kak Choi, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/602,158

(22) Filed: Nov. 20, 2006

(30) Foreign Application Priority Data
Jun. 9, 2006 (KR) 10-2006-0052029

(51) Int. Cl. B60K 1/00

(52) U.S. Cl. 180/65.1; 903/943

(57) ABSTRACT

A method for controlling charge and discharge amounts of a main battery for a hybrid car includes receiving signals from the main battery, a driving motor, and an inverter system; and controlling charge and discharge amounts of the main battery through adjusting and learning a scale factor of the main battery in conformity with a driver's driving pattern so that a state of charge is administrated in a normal zone. A system for controlling charge and discharge amounts of a main battery for a hybrid car includes a main battery; a driving motor; an inverter system; and a hybrid control unit receiving signals from the battery, motor, and inverter system, and controlling charge and discharge amounts of the main battery through adjusting and learning a scale factor of the main battery in conformity with a driver's driving pattern so that a state of charge is administrated in a normal zone.

### CROSS-REFERENCE TO RELATED APPLICATIONS

The present application is based on, and claims priority from, Korean Application Serial Number 10-2006-0052029, filed on Jun. 9, 2006, the disclosure of which is hereby incorporated by reference herein in its entirety.

### BACKGROUND OF THE INVENTION

1. Field of the Invention

The present invention relates to a method and system for controlling charge and discharge amounts of a main battery for a hybrid car.

2. Description of the Related Art

As is generally known in the art, a hybrid car represents a vehicle which is driven using two power sources. A battery is used as an energy storage device for the hybrid car.

The control of the state of charge of the battery provided to a hybrid car is an important factor for determining the fuel economy and the performance of the hybrid car. That is to say, depending upon the state of charge of the battery, an assist amount and a regenerative braking amount are determined.

The most important factor in controlling the state of charge of the battery is to ensure that the battery operates with maximum efficiency. Due to the characteristics of a battery, charge and discharge efficiency of the battery varies depending upon the state of charge of the battery.

The state of charge of the battery is divided into three zones by the charge and discharge efficiency of the battery. A normal zone corresponds to the interval which has the state of charge of 55˜60%±5%, an over-charge zone as the upper zone of the normal zone corresponds to the interval which has the state of charge of greater than 65%, and an over-discharge zone as the lower zone of the normal zone corresponds to the interval which has the state of charge of less than 55%.

Since the current logic system for controlling the state of charge of the battery adopts a fixed scale factor, the operation of the battery cannot be effectively suited for the various driving patterns of drivers.

As a consequence, a drawback is caused in that, since the battery which must be operated in the normal zone is likely to be operated in the over-charge zone or the over-discharge zone, the lifetime of the battery can be shortened and it is difficult to stably assist the hybrid car.

That is to say, if time elapses while the battery has a low state of charge, the memory effect of the battery and the load of an engine increase, whereby the efficiency of the car is deteriorated and the lifetime of the battery is shortened.

### SUMMARY OF THE INVENTION

Embodiments of the present invention provide a method and system for controlling charge and discharge amounts of a main battery for a hybrid car so that the lifetime of the main battery is extended and the state of charge of the main battery is administrated in a normal zone irrespective of various driving patterns of drivers to thereby improve fuel economy.

In one exemplary embodiment of the present invention, there is provided a method for controlling charge and discharge amounts of a main battery for a hybrid car, comprising steps of sensing a vehicle operation state based on signals input from a main battery, a driving motor, an inverter system, and so forth, by a hybrid control unit provided to the hybrid car; driving the hybrid car in accordance with a driving pattern of a driver, and controlling, by the hybrid control unit, charge and discharge amounts of the main battery through adjusting and learning a scale factor of the main battery in conformity with the driving pattern of the driver so that a state of charge is administrated in a normal zone.

According to another aspect of the present invention, the step of driving the hybrid car in accordance with a driving pattern of a driver comprises a step in which the main battery enters an over-discharge zone as the hybrid car travels in a suddenly accelerated state.

According to another aspect of the present invention, the step of driving the hybrid car in accordance with a driving pattern of a driver comprises a step in which the main battery enters an over-charge zone as the hybrid car is stopped or travels at a constant speed.

According to another aspect of the present invention, the step of driving the hybrid car in accordance with a driving pattern of a driver comprises a step in which the main battery enters an over-discharge zone as the hybrid car travels in a suddenly decelerated state.

According to still another aspect of the present invention, the method further comprises a step of storing data of control conducted by the hybrid control unit in conformity with the driving pattern of the driver in a memory of the hybrid control unit

According to yet still another aspect of the present invention, the method further comprises a step of readjusting a charge amount of the main battery by the hybrid control unit when the driver or a load is changed.

In one exemplary embodiment of the present invention, there is provided a system for controlling charge and discharge amounts of a main battery for a hybrid car, comprising a main battery, a driving motor, an inverter system, and a hybrid control unit that receives signals from the main battery, the driving motor, and the inverter system, and controls charge and discharge amounts of the main battery through adjusting and learning a scale factor of the main battery in conformity with a driving pattern of a driver so that a state of charge is administrated in a normal zone.

The main battery may enter an over-discharge zone when the car suddenly accelerates, and may enter an over-charge zone when the car is stopped, travels at a constant speed, or suddenly decelerates.

The hybrid control unit may include a memory that stores data of control in conformity with the driving pattern of the driver.

The hybrid control unit may readjust a charge amount of the main battery when the driver changes or when a load is added to or removed from the car.

### BRIEF DESCRIPTION OF THE DRAWINGS

The above and other objects, features and advantages of the present invention will be more apparent from the following detailed description when taken in conjunction with the accompanying drawings, in which:

FIG. 1 is a flow chart illustrating an embodiment of a method for controlling charge and discharge amounts of a main battery for a hybrid car in accordance with the present invention;

FIG. 2 is a diagrammatic view illustrating the zones of the state of charge of the main battery for a hybrid car;

FIG. 3 is a flow chart illustrating another embodiment of the method for controlling charge and discharge amounts of a main battery for a hybrid car, and

FIG. 4 is a block diagram illustrating a system for controlling charge and discharge amounts of a main battery for a hybrid car in accordance with exemplary embodiments of the present invention.

### DETAILED DESCRIPTION OF THE PREFERRED EMBODIMENTS

Reference will now be made in greater detail to embodiments of the invention, examples of which are illustrated in the accompanying drawings. Wherever possible, the same reference numerals will be used throughout the drawings and the description to refer to the same or like parts.

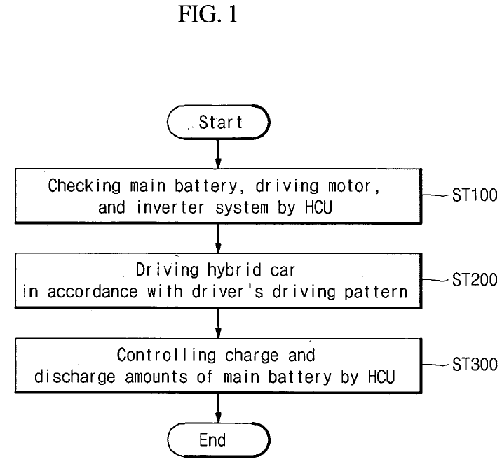

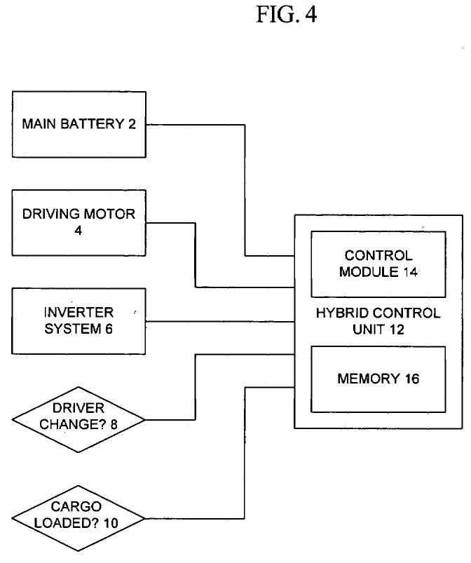

Referring to FIGS. 1, 2, and 4, in a state in which a driver boards a hybrid car and an engine is started, a main battery 2, a driving motor 4, an inverter system 6, and so forth are checked by a hybrid control unit 12 at step ST100.

The hybrid control unit 12 may include a control module 14, which may include a processor; a memory 16; and other hardware; software; and/or firmware as may be selected and programmed by persons of ordinary skill in the art based on the teachings herein.

In step ST100, whether or not errors have occurred in the above-described components is checked by the control module 14. Then, the hybrid car is driven in accordance with the driving pattern of the driver who has boarded the hybrid car at step ST200.

In step ST200, in which the hybrid car is driven in accordance with the driving pattern of the driver, while the hybrid car travels at a constant speed, if the driver suddenly steps on the accelerator pedal and the speed of the hybrid car is momentarily increased to cause the hybrid car to travel in a suddenly accelerated state, the main battery enters an over-discharge zone at step ST210. Also, if the hybrid car is stopped or travels at a constant speed, the main battery enters an over-charge zone at step ST220.

Moreover, if the driver suddenly steps on the brake pedal and the speed of the hybrid car is momentarily decreased to cause the hybrid car to travel in a suddenly decelerated state, the main battery enters an over-charge zone at step ST230. More detailed explanations regarding the respective traveling conditions are provided below.

The scale factor of the main battery 2 is controlled such that the charge and discharge amounts of the main battery 2 are administrated within the normal zone in conformity with the driving pattern of the driver having boarded the hybrid car at step ST300.

In one embodiment of the present invention, the scale factor is a multiplication factor. In the normal zone of the main battery, the scale factor is 1. A scale factor of 1 indicates the value which is initially calibrated by an engineer in view of the output of the driving motor.

If the state of charge of the main battery 2 goes out of the normal zone, the scale factor is controlled by the hybrid control unit to be learned and memorized, which will be described below in more detail.

Data related to control implemented by the hybrid control unit in conformity with the driving pattern of the driver is saved in the memory 16 in the hybrid control unit at step ST400. If the driver or a load is changed, the charge amount of the main battery is readjusted by the hybrid control unit at step ST500.

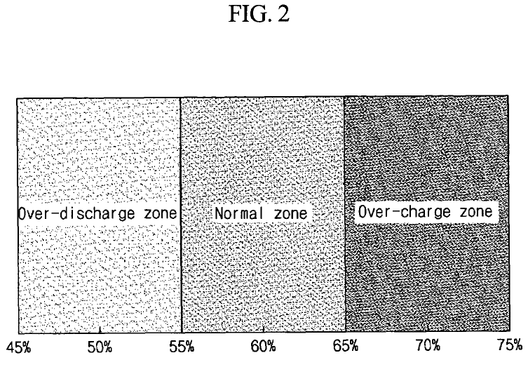

Referring to FIG. 2, the state of charge of the battery has a normal zone of 55%˜65%, an over-charge zone of 65%˜75%, and an over-discharge zone of 45%˜55%.

The status of the hybrid car in the respective zones will be described below with reference to an embodiment of the present invention.

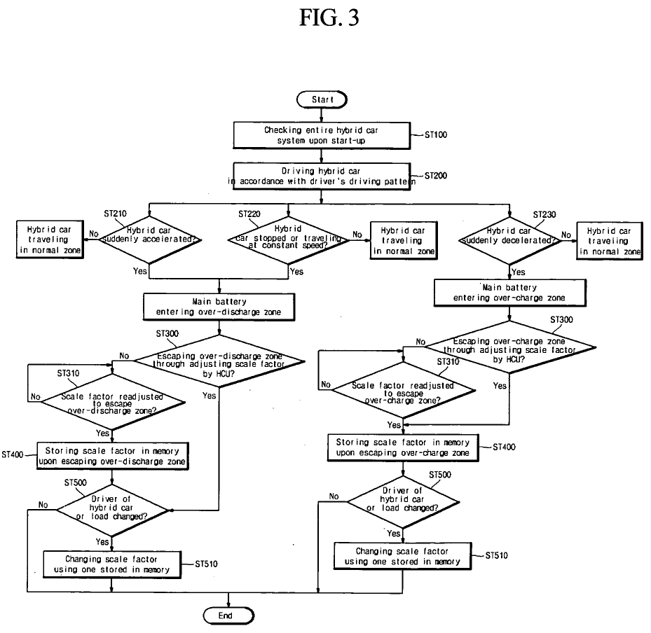

Referring to FIG. 3, if the engine is started, all component elements which are essential to drive the hybrid car, including but not limited to the main battery 2, the driving motor 4, and the inverter system 6, are checked by the hybrid control unit at step ST100. With the checking completed, the hybrid car is driven by the driver at step ST200.

If the driver drives the car with a hasty driving pattern through frequently accelerating or decelerating the car (ST210), the state of charge of the main battery 2 transfers to the over-discharge zone (see FIG. 2).

That is to say, the discharge amount of the main battery increases due to the driving pattern of a driver who frequently accelerates the car, and the charge amount of the main battery decreases due to the driving pattern of a driver who frequently decelerates the car. As a result, the state of charge of the main battery moves to the over-discharge zone.

If the main battery is in the over-discharge zone as described above, since unnecessary charge is frequently conducted, the charge amount of the main battery 2 is controlled by the hybrid control unit 12 (ST300).

Due to the fact that the hybrid control unit 12 is provided with the separate control module 14, the scale factor is adjusted such that the state of charge of the main battery 2 is moved from the over-discharge zone to the normal zone.

If the state of charge of the main battery 2 does not escape from the over-discharge zone by the control module 14 when a predetermined time (e.g. 5 minutes) has elapsed after it moved to the over-discharge zone, the scale factor is increased such that the state of charge of the main battery 2 can escape from the over-discharge zone (ST310).

In the over-discharge zone as described above, the use of the driving motor 4 is decreased to a certain extent such that the main battery 2 can be charged as quickly as possible.

In this way, if the state of charge of the main battery 2 escapes the over-discharge zone, information regarding the adjusted scale factors is stored in the memory 16 (ST400) so that the information can be used when the state of charge of the main battery 2 has moved again to the over-discharge zone.

If the driver of the hybrid car changes (8) or cargo is additionally loaded on the hybrid car (10), the charge amount of the main battery is readjusted by the control module of the hybrid control unit at step ST500.

The readjustment of the state of charge of the main battery uses the scale factor stored in the memory 16 at step ST510, and an increment is added to the stored scale factor such that the state of charge of the main battery can escape from the over-discharge zone when a predetermined time (for example 2 minutes) has elapsed after it enters the over-discharge zone.

For example, when assuming that the stored scale factor is 0.9, if the state of charge of the main battery escapes from the over-discharge zone within 2 minutes as the driver is changed or the weight of the hybrid car is increased, 0.05 is added to the stored scale factor to have the total scale factor of 0.95.

If the scale factor of the main battery is increased as described above, a driving current applied to the driving motor is increased so that the state of charge of the main battery can transfer to the normal zone.

If the state of charge of the main battery in the over-discharge zone is controlled as described above, an assist scale is adjusted so that the driving force of the driving motor is added to the driving force generated from the engine (not shown) to assist the hybrid car.

Because the adjustment of a charge amount scale factor from the over-discharge zone when the hybrid car is stopped or travels at a constant speed as on an express high way (ST220) is similar to the procedure as described above, detailed description thereof will omitted herein.

If the hybrid car travels in a suddenly decelerated state at step ST230, the state of charge of the main battery is moved to the over-charge zone (see FIG. 2).

That is to say, the discharge amount of the main battery decreases due to the driving pattern of a driver who frequently decelerates the car, as a result of which the state of charge of the main battery is moved to the over-charge zone.

If the main battery is in the over-charge zone as described above, since unnecessary discharge is frequently conducted, the charge amount of the main battery is controlled by the hybrid control unit 12 at step ST300.

Due to the fact that the hybrid control unit 12 is provided with the separate control module 14, the scale factor is adjusted such that the state of charge of the main battery is moved from the over-charge zone to the normal zone.

If the state of charge of the main battery does not escape from the over-charge zone by the control module 14 when a predetermined time (for example 5 minutes) has elapsed after it has moved to the over-charge zone, the scale factor is increased such that the state of charge of the main battery can escape from the over-charge zone at step ST310.

In the over-charge zone as described above, under the control of the hybrid control unit, the use of the driving motor 4 is increased to a certain extent such that the main battery can be discharged as quickly as possible. In this way, if the state of charge of the main battery escapes from the over-charge zone, information regarding the adjusted scale factors is stored in the memory 16 at step ST400 so that the information can be used when the state of charge of the main battery is moved again to the over-charge zone.

If the driver of the hybrid car changes (8) or cargo is additionally loaded on the hybrid car (10), the charge amount of the main battery is readjusted by the control module of the hybrid control unit at step ST500.

The readjustment of the state of charge of the main battery uses the scale factor stored in the memory 16 (ST510), a decrement is subtracted from the stored scale factor such that the state of charge of the main battery can escape from the over-charge zone when a predetermined time (e.g. 2 minutes) has elapsed after it enters the over-charge zone.

For example, when assuming that the stored scale factor is 1.1, if the state of charge of the main battery escapes from the over-charge zone within 2 minutes as the driver is changed or the weight of the hybrid car is increased, 0.05 is subtracted from the stored scale factor to have the total scale factor of 1.05.

Therefore, the hybrid car is assisted such that the state of charge of the main battery is moved from the over-charge zone to the normal zone, and in this state, the hybrid car can be driven as desired.

As is apparent from the above description, systems and methods for controlling charge and discharge amounts of a main battery for a hybrid car according to the present invention provide advantages in that since the over-charge and the over-discharge of a main battery can be avoided, the operational error of the main battery can be prevented, and the durability of the main battery can be improved.

Further, due to the fact that a scale factor can be adjusted depending upon a driver's driving pattern and the standardization of the main battery in conformity with the driving characteristic of the driver is possible, the main battery can be administrated as intended by a designer, and the marketability of the hybrid car can be improved.

Moreover, because consistency in fuel economy and exhaust tests can be ensured in the initial development step of the hybrid car, stability of the entire system of the hybrid car can be accomplished.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for controlling charge and discharge amounts of a main battery for a hybrid car, comprising the steps of:
sensing a vehicle operation state based on signals input from the main battery, a driving motor, and an inverter system; and
controlling charge and discharge amounts of the main battery, said controlling comprising adjusting and learning a scale factor of the main battery in conformity with a driving pattern of a driver so that a state of charge is administrated in a normal zone.

2. The method as claimed in claim 1, wherein the main battery enters an over-discharge zone when the hybrid car suddenly accelerates.

3. The method as claimed in claim 1, wherein the main battery enters an over-charge zone when the hybrid car is stopped or travels at a constant speed.

4. The method as claimed in claim 1, wherein the main battery enters an over-charge zone when the hybrid car suddenly decelerates.

5. The method as claimed in claim 1, further comprising storing data of control in conformity with the driving pattern of the driver.

6. The method as claimed in claim 1, further comprising readjusting a charge amount of the main battery when the driver or a load changes.

7. A system for controlling charge and discharge amounts of a main battery for a hybrid car, comprising:
a main battery outputting a signal indicative of main battery status;
a driving motor outputting a signal indicative of driving motor status;
an inverter system outputting a signal indicative of inverter system status; and
a hybrid control unit receiving said signals and controlling charge and discharge amounts of the main battery, said controlling comprising adjusting and learning a scale factor of the main battery in conformity with a driving pattern of a driver so that a state of charge is administrated in a normal zone.

8. The system as claimed in claim 7, wherein the main battery enters an over-discharge zone when the hybrid car suddenly accelerates.

9. The system as claimed in claim 7, wherein the main battery enters an over-charge zone when the hybrid car is stopped or travels at a constant speed.

10. The system as claimed in claim 7, wherein the main battery enters an over-charge zone when the hybrid car suddenly decelerates.

11. The system as claimed in claim 7, wherein the hybrid control unit comprises a memory that stores data of control in conformity with the driving pattern of the driver.

12. The system as claimed in claim 7, wherein the hybrid control unit readjusts a charge amount of the main battery when the driver or a load changes.
